(19) United States
(12) Patent Application Publication
(10) Pub. No.: US 2005/0104258 A1
(43) Pub. Date: May 19, 2005

(54) Patterned electrospinning

(75) Inventor: John D. Lennhoff, North Andover, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Physical Sciences, Inc., Andover, MA (US)

(21) Appl. No.: 10/967,627

(22) Filed: Oct. 18, 2004

Related U.S. Application Data
(63) Continuation-in-part of application No. 10/884,796, filed on Jul. 1, 2004.
(60) Provisional application No. 60/484,335, filed on Jul. 2, 2003.
(60) Provisional application No. 60/511,808, filed on Oct. 16, 2003.

(51) Int. Cl. D01D 5/098; B29C 47/00

(52) U.S. Cl. 264/465; 425/174.8 R; 425/382.2

(57) ABSTRACT

A polymer is directed from a source electrode into an electric field that drives the formation of electrospun fibers that are deposited onto a collecting surface to thereby form a patterned polymer structure. The collecting surface can be a counterelectrode or a collecting surface that is between the source electrode and a counterelectrode. Apparatus employed to conduct the method include an electrospinning source that directs polymer into an electric field formed by source and counterelectrodes. A collecting surface, such as the counterelectrode or a surface interposed between the source and counterelectrodes, collects electrospun fibers. Articles of manufacture formed by the method of apparatus include, for example, a structure of patterned electrospun fibers comprising multiple aggregations of polymeric electrospun fibers.

### RELATED APPLICATIONS

This application is a continuation-in-part of U.S. application Ser. No. 10/884,796, filed on Jul. 1, 2004, which claims the benefit of U.S. Provisional Application No. 60/484,335, filed on Jul. 2, 2003. In addition, this application claims priority to U.S. Provisional Application No. 60/511,808, filed on Oct. 16, 2003. The entire teachings of these applications are incorporated herein by reference.

### BACKGROUND OF THE INVENTION

Electrospinning is a process used to produce nanometer diameter scale fibers. A fine stream or jet of fiber-forming polymeric material, in solution or as a melt, is injected into an electric field and the electric forces move the material through space. Upon evaporation of the solvent or cooling of the melt, small-diameter electrospun fibers (e.g., in the nanometric diameter range) are formed. Embodiments of electrospinning have been described in, for example, “Electrospinning Process and Applications of Electrospun Fibers” by Doshi and Reneker, Journal of Electrostatics, Vol. 35 (1995), pp. 151-160, “Nanometre Diameter Fibres of Polymer, Produced by Electrospinning” by Reneker and Chun, Nanotechnology, Vol. 7 (1996), pp. 216-223, and “DNA Fibers by Electrospinning” by Fang and Reneker, Journal of Macromolecular Science and Physics, Vol. B36(2) (1997), pp. 169-173, the teachings of which are incorporated by reference in their entirety.

Generally, electrospinning employs an electrical potential applied between a zone in which the polymer solution or melt is introduced and a zone in which the electrospun fibers are collected. Electric charges tend to move in response to the electrical field associated with the electric potential and these charges transfer forces to the polymer mass. The radial forces from the electric charges carried by the jet or stream of fiber-forming material cause the fibers to whip and move at high velocity (˜10 m/s) in a cone-shaped volume centered in an electric field of approximately equal diameter and charge per unit length. The divided jets repel each other, thereby acquiring lateral velocities and chaotic trajectories.

Typically, the electrospun fibers are collected in a random, non-woven mat of fibers on an electrode plate (e.g., as described in U.S. Pat. No. 6,110,590) or on a substrate to which the fibers are to be attached to form a composite structure (e.g., as described in U.S. Pat. No. 6,265,333 B1). Such fibers may also be directed to form an array of the fibers using the electric field forces (e.g., using a charged twister electrode and a spinning ground electrodes to form a yam bundle, as described in U.S. Pat. No. 4,468,922) alone or together with pneumatic forces (e.g., use of an air vortex, as described in U.S. Pat. No. 6,106,913).

The properties of the electrospun fibers per se can be critically important and improved techniques to enhance fiber properties have been sought. For example, in U.S. Pat. No. 4,552,707, a method of collecting electrospun fibers on a variable-speed rotating charged mandrel is employed to affect the anisotropy of fibers incorporated in vascular grafts. Additionally, U.S. Pat. No. 6,265,466 B1 describes the use of shearing, stretching or elongating steps applied to electrospun nanofibers to enhance their electromagnetic shielding properties.

The arrangement of electrospun fibers can be important for other applications. However, generally, known methods for electrospinning polymer fibers exhibit limited control over deposit of those fibers on a surface.

### SUMMARY OF THE INVENTION

The present invention relates to methods of making patterns of electrospun fibers, apparatus suitable for making such patterns, and articles having electrospun fibers in a pattern.

The methods of this invention form a patterned polymer structure of electrospun fibers by directing a polymer stream from a spinning source in an electric field created by source and counterelectrodes, whereby the polymer forms electrospun fibers. The electrospun fibers are deposited onto a collecting surface in a pattern, thereby forming a patterned polymer structure. The collecting surface can be either the counterelectrode or a suitable surface, such as a dielectric surface, that is separated from and between the counterelectrode and the source electrode.

In one embodiment, the invention includes a method for forming a patterned polymer structure, comprising the step of directing a polymer from a source electrode into an electric field that drives the polymer to form electrospun fibers and deposits the electrospun fibers onto a portion of a collecting surface between and separated from the source electrode and counterelectrodes, thereby forming the patterned polymer structure.

In another embodiment, this invention includes a method for forming a patterned structure of electrospun fibers. The method includes electrically directing fiber-forming polymeric material from a spinning source in an electric field created by source and counterelectrodes, the counterelectrode forming concentrations of electrical charges which include a patterned array in a plane that traverses the electric field; and interposing a collecting surface at the plane, whereby the directed fibers are deposited on the collecting surface in aggregations that are essentially the same pattern as formed by the concentrations of electrical charge.

In still another embodiment, this invention includes a method for forming a patterned structure of electrospun fibers. In this embodiment, the method includes directing a polymer stream into an electric field created by source and counterelectrodes, the electric field including a pattern of electric charge at a collecting surface between the source and counterelectrodes, whereby the polymer stream splays to form electrospun fibers that deposit onto the collecting surface as a structure having the pattern of electric charge at the collecting surface.

In one embodiment, this invention includes an apparatus for forming a patterned array of electrospun fibers. The apparatus includes means for electrically directing fibers from a spinning source in an electric field created by one or more source and counterelectrodes. The counterelectrodes produce at least one concentration of electrical charge. A collecting surface is between the source and counterelectrodes.

In another embodiment, this invention includes articles of manufacture that includes multiple aggregations of polymeric electrospun fibers defining at least one area between the aggregations.

In one embodiment, this invention includes an article of manufacture produced by a method for forming a patterned polymer structure. A polymer is directed from a source electrode into an electric field that drives the polymer to form electrospun fibers and deposits the electrospun fibers onto a collecting surface, thereby forming the patterned polymer structure.

The present invention provides for the production of structures of electrospun fibers, the deposition of which can be controlled so that the fibers can be precisely patterned in a predetermined manner. For example, the fibers can be precisely patterned in a predermined manner on an insulating substrate (e.g., a polymer film) or directly onto a patterned counterelectrode. The articles of this invention provide nanofibers deposited in a desired pattern. Such fibers are useful in the fields of electronics, optics, adhesives, and filtration.

The processes and articles of this invention are useful a wide range of articles of applications, including polymer film reinforcement, fabrication of high surface area fibrillar electrodes, engineered nanofiber filters and ultra-light weight membranes.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic representation of an electrospinning process and apparatus of the invention wherein the apparatus includes a movable counterelectrode.

FIG. 2 is a schematic representation of an electrospinning process and apparatus of the invention wherein the apparatus includes a stationary counterelectrode.

FIG. 3 is a schematic representation of a patterned polymer structure of the invention.

FIG. 4 is an optical micrograph of an article of one embodiment of the invention wherein electrospun fiber aggregates are deposited on Mylar™ polyester film.

FIG. 5 is a graph showing electrospun fiber aggregate size as a function of distance of a collecting surface from a counterelectrode at two different strengths of electric field.

FIG. 6 is a photograph of electrospun fibers and a pattern of fiber aggregation deposited on a Kapton® polyimide film using a continuous metal sheet with 0.25 inch diameter holes as the ground electrode.

FIG. 7 is a photograph of electrospun fibers (white) patterned onto a camouflage fabric substrate.

FIG. 8 illustrates a graph of the force required during delamination of the patterned adhesive shown in FIG. 7. The graph shows period consistent with the spacing of the pattern.

FIG. 9 illustrates a scanning electron microscope image of a 0.5 mm wide patterned electrospun rip-stop reinforcement strip on a thin polyimide film. The spots in the stripe are inkjet printed solvent welds.

FIG. 10 is a photograph of a patterned electrospun rip-stop reinforcement on a Mylar® sheet (˜0.9 microns thick; E.I. du Pont de Nemours and Company Corp.). Tear propagation is seen through the film, but the propagation stops at the electrospun reinforcement.

FIG. 11 is a photograph of the film shown in FIG. 10 after subjected to additional tear propagation. Tear propagating is seen through the film, but the electrospun reinforcement holds the film together.

### DETAILED DESCRIPTION OF THE INVENTION

The features and other details of the apparatus and methods of the invention will now be more particularly described with reference to the accompanying drawings and pointed out in the claims. It will be understood that the particular embodiments of the invention are shown by way of illustration and not as limitations of the invention. The principal features of this invention can be employed in various embodiments without departing from the scope of the invention. All parts and percentages are by weight unless otherwise specified.

Electrospinning in accordance with the present invention includes use of a spinning source in an electric field that is created by one or more source and counterelectrodes. Fiber-forming polymeric material from a spinning source is directed into the electric field. The spinning process is driven by the electrical forces, generally in the form of free charges on the surface or inside the polymeric material. The spinning source has one or more orifices from which the polymeric material is ejected and can be oriented anywhere in space in or adjacent to the electric field; for example, the spinning source can be in the electric field, above the electric field, below the electric field, or horizontally adjacent to the electric field. The counterelectrode(s) is a component or components toward which the stream or jet of polymeric fluid is directed due the presence of concentrations or areas of electric charge directed to the counterelectrode(s). In one embodiment, the electrospun fibers are deposited onto a counterelectrode to form a patterned electrospun material. For example, the electrospun fibers can be deposited on a patterned counterelectrode in an amount sufficient to form a patterned electrospun material. Alernatively, a collecting surface can be interposed between the source and counterelectrodes. In other embodiments, the collecting surface comprises an insulating material. The counterelectrode(s) have electrically charged areas which are in the form of (or are moved to form) a pattern, such as an array. One or more counterelectrodes may be used and the movements of moveable counterelectrodes combine to create a desired pattern in the electric field, resulting in deposition of fibers on the collecting surface in essentially that same pattern.

Electrical charges (e.g., in the form of charged ions) move toward charged areas of the counterelectrode (e.g., conductive areas of the electrode). The electrospun fibers are directed toward the electrically charged areas and are collected as one or more aggregations of electrospun fibers on the collecting surface in essentially that same array or pattern, since the collecting surface intercepts the fiber streams directed by electric charges moving in electric field lines established by the counterelectrodes and toward the electrically charged areas thereof. As described below, the distance of the collecting surface from the counterelectrode can be employed to control aggregation at the collecting surface, such as the diameter of a circular aggregation of electrospun fibers at a collecting surface.

Generally, the spinning source is electrically connected to a source electrode and an electric field is created between the source electrode and counterelectrode. The electric field should be strong enough to overcome gravitational forces on the polymer solution or melt material, overcome surface tension forces of the material, provide enough force to form a stream or jet of solution in space, and accelerate that stream or jet across the electric field. As the skilled artisan will recognize, surface tension is a function of many variables. These variables include, for example, the type of polymer solution or melt, viscosity of the polymer solution or melt, and the temperature. A potential in a range of between about 3 and about 30 volts (V) between the fiber solution/melt delivery point and the capture zone is generally sufficient, with the electrical field created in the region near the counterelectrode generally being in a range of between about 0.3 and about 3 kV/cm. In one embodiment, an electric potential of about 15,000 V and an electric field of about 150 kV/m is suitable. The field should be strong enough to drive a stream of polymer solution in the electric field and to collect resulting electrode fibers on a collecting surface.

Although the present invention is not to be limited by any underlying technical explanation or theory of operation, it may be helpful to recognize that an electric potential creates an electric field in the space surrounding it. An electric field is generally defined as being present in any region where a charged object experiences an electric force and can be visualized on paper by drawing lines of force, which give an indication of both the size and the strength of the field. These lines of force are commonly referred to as field lines. Field lines start on positive charges and end on negative charges, and the direction of the field line at a point indicates what direction the force experienced by a charge will be if the charge is placed at that point (e.g., if the charge is positive, it will experience a force in the same direction as the field). Accordingly, one can visualize the electrospun fibers herein as being directed along the field lines which are established by the pattern of the electrically charged areas of the counterelectrode, with the fibers being intercepted in this same pattern at a collecting surface since the movement of charges is along the field lines to the electrically charged areas of the counterelectrodes. For example, when one or more moveable counterelectrodes are used, the field lines move relative to a collecting surface in a pattern which tracks the electrodes' movements and the points at which the field lines pass through the collecting surface changes in accordance with the electrodes' movements.

The electrified field necessary to create a stream of fiber solution through space can be achieved by charging the spinning source/source electrode or the counterelectrode. Where the spinning source/source electrode is charged, the counterelectrode will be grounded. Conversely, where the counterelectrode is charged, the spinning source/source electrode will be grounded.

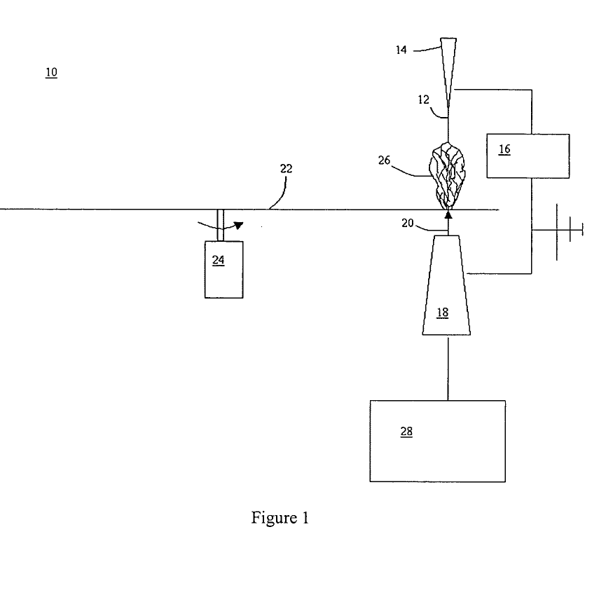

One embodiment of the invention is shown as apparatus 10 of this invention in FIG. 1. Polymeric material 12 is ejected from spinning source 14 into an electric field which is established by power supply 16. The power supply is electrically connected to spinning source 14 and creates an electrical potential between spinning source 14 and counterelectrode(s) 18 which have one or more electrically charged areas 20. Collecting surface 22 is interposed between spinning source 14 and counterelectrode(s) 18. Collecting surface 22 may be stationary or movably driven by drive rollers or other means 24, thereby providing relative movement (e.g., a rotational translation). One or more streams or jets of polymeric material 12 are ejected from spinning source 14 into the electric field and the material separates (“splays”) into electrospun fibers 26. Electrospun fibers 26 are directed toward electrically charged area 20 and are deposited onto a portion collecting of surface 22 as one more of aggregates, thereby forming a patterned polymer structure. In one embodiment of the invention, counterelectrode(s) 18 is configured to provide that deposition of electrospun fibers 26 on collecting surface 22 will be in a predetermined specific pattern. Collecting surface 22 may be a material (e.g., a Mylar® polyester film) upon which fibers are to be deposited (e.g., wherein the patterned polymer structure is a composite of the film and the aggregated electrospun fibers). Alternatively, collecting surface 22 may be a material selected to enable the aggregated electrospun fibers to be removed, wherein the aggregation of electrospun fibers is the patterned polymer structure.

Counterelectrode 18, as shown in FIG. 1, has a smaller electrically-charged area than collecting surface 22 and is connected to programmable controller 28, which can direct the movement of the counterelectrode 18 essentially parallel to collecting surface 22, including allowing time intervals in which counterelectrode 18 remains stationary. Movements of counterelectrode 18 relative to collecting surface 22 can be intermittent or continuous, or both. Programmable controller 28 can also be employed to move counterelectrode 20 closer or farther away from collecting surface 22. All of those movements of counterelectrode 18 can be done simultaneously, and in combination with movement of collecting surface 22, by activation of means 24. Activation of means 24 can also be done to move collecting surface 22 in the absence of activation of controller 28, and can also be intermittant or continuous. The relative movement of collecting surface 22 to counterelectrode 18 can be intermittent or continuous. If only one aggregation of electrospun fibers is desired, the counterelectrode 18 may be one stationary device (and the programmable controller 28 is not needed) and a patterned surface having a single aggregation can be produced. If a patterned surface having multiple aggregations is desired, appropriate programming of the X-Y programmable controller can, together with the movement, if any, of collecting surface 22, produce a predetermined pattern of aggregations of the desired density in single or multiple layers, since the electrospun fibers are attracted to the electrically charged area and are deposited on collecting surface 22 in essentially the same pattern created by the programmed movements.

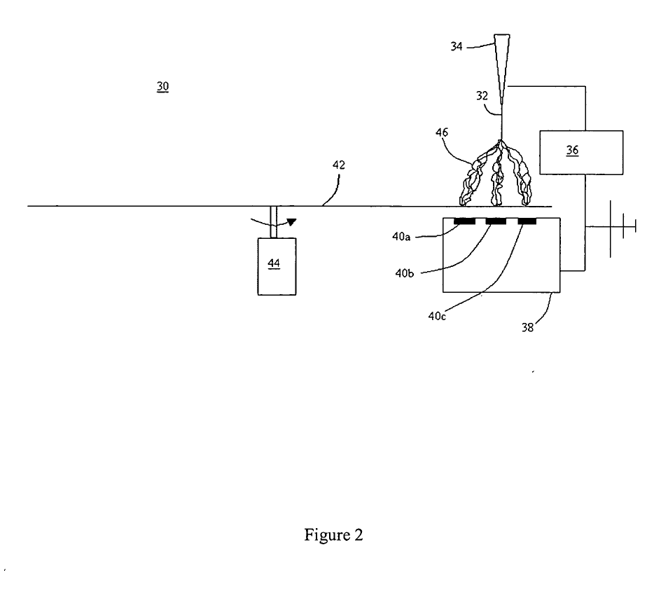

An alternate embodiment of an apparatus of this invention is shown in FIG. 2. Spinning apparatus 30 directs polymeric material 32 from spinning source 34. An electric field is established by power supply 36, which is electrically connected to spinning source 34 and creates an electrical potential between spinning source 34 and stationary counterelectrode(s) 38. Collecting surface 42 is interposed between the spinning source 34 and the counterelectrode(s) 38. Collecting surface 42 may be stationary or movably driven by drive rollers or other means 44. Multiple electrically charged areas, depicted for simplicity as three areas, 40a, 40b and 40c, produce a pattern of areas in which electric charges are concentrated (i.e., a patterned concentration of electric charge) at the points on counterelectrode(s) 38, which form lines of force (not shown) of the electric field which intersect collecting surface 42. One or more streams or jets of polymeric material 32 are ejected from spinning source 34 into the electric field which drives the formation of electrospun fibers 46. Electrospun fibers 46 collect as distinct aggregations on collecting surface 42, most proximate to the lines of force leading to electrically charged areas 40a, 40b and 40c. Counterelectrode 38 is configured to provide that deposition on collecting surface 42 is in a predetermined specific pattern.

Electrically charged areas 40a, 40b and 40c shown in FIG. 2 facilitate formation of fiber aggregations in a predetermined pattern, since the electrospun fibers are attracted toward these electrically charged areas and are deposited as fiber aggregations on collecting surface 42 in essentially the same pattern. The duration of deposition is selected to achieve the desired fiber density or layer thickness.

Generally, electrospinning produces fibers having a diameter in a range of between about 5 nanometers and about 5000 nanometers (nm), although fibers with even finer diameters can be produced. In the practice of this invention, fibers having diameters in the range of about to 50 to about 800 nm are preferred. Essentially any polymeric composition can be fiber-forming and electrospun to produce nanofibers, so long as a suitable solution (including an appropriate solvent or solvent mixture for the polymer) or polymer melt can be formed and the molecular weight is sufficient.

The particular polymeric material used in this invention is a material capable of being formed into fibers by electrospinning (e.g., from polymer solutions or molten polymer). Typically, the material will be chosen in accordance with the structural, strength, design, etc., parameters desirable for the fiber in a given application. A wide range of polymeric resins, natural or synthetic, are suitable. The polymeric resins are carbonizable or non-carbonizable. These include thermoplastics, thermosets, and elastomers. Thus, suitable synthetic polymeric resins include, but are not limited to, polyethylene, polypropylene, polyvinyl chloride, styrenics, polyurethanes, polyimides, polycarbonate, polyethylene terephthalate, acrylics, phenolics, unsaturated polyesters, etc. Suitable natural polymers include, for example, cellulose, gelatin, chitin, polypeptides, polysaccharides, or other polymeric materials of plant, animal, or microbial origin. Examples of preferred polymers are set forth, for example, in Table 1 of U.S. Pat. No. 6,265,333 B1, the teachings of which are incorporated herein by reference in their entirety.

The polymeric materials can contain other ingredients and additives, such as are well known in the field of polymers, to provide various desirable properties. Typically, these other substances are present in amounts less than about 5 weight percent. The polymeric materials can be crystalline, partially crystalline, amorphous, cross-linked, etc., as may be suitable for the given application.

An article of manufacture according to this invention is formed by depositing electrospun fibers upon a material interposed between the spinning source and the patterned electrically charged areas of the counterelectrode. Deposition of the electrospun fibers on an interposed collecting surface, such as a sheet of Mylar® polyester film, can produce the patterned polymer structure as a composite which includes the collecting surface (e.g., a electrospun fiber/Mylar® composite). Other suitable collecting surfaces include, for example, a polymer sheet such as a polyimide film (e.g., CP1 or Kapton®, available from E.I. du Pont de Nemours & Co., Wilmington, Del.), paper, CP-1, or a fabric.

In another embodiment of this invention, the electrospun fiber is deposited or collected on the counterelectrode surface or on a counterelectrode directly in contact with the collecting surface. In such an embodiment, the nature of the electrospun fiber and/or the electrode material or its design needs to be appropriately selected, otherwise removal of the deposited electrospun fiber layer may be difficult (i.e., without altering or destroying the fiber layer and/or pattern of the fibers).

In addition to Mylar® polyester film, other suitable materials for positioning between the spinning source and the electrically charged areas of the counterelectrode include virtually any insulating material.

In another embodiment, this invention provides a patterned structure comprised one or more layers of electrostatically spun fibers containing essentially circular multiple fiber aggregations. In some embodiments, the aggregations are about 0.5 mm or less in diameter.

A “patterned polymer structure,” as defined herein, means at least one aggregation of electrospun polymer fibers. In one embodiment, the patterned polymer structure can be an article of manufacture that includes multiple aggregations of polymeric electrospun fibers defining at least one area between the aggregations. The patterned polymer structure can be, in another embodiment, a composite, wherein a single aggregation of electrospun fibers occupies a portion of a collecting surface. The patterned polymer structure can be symmetric or repeated aggregations of electrospun fibers separated by one or more essentially unoccupied areas of the collecting surface. The symmetric or repeated aggregations may be, for example, in a sawtooth or zig-zag pattern array or other type of regular grouping or arrangement of aggregations.

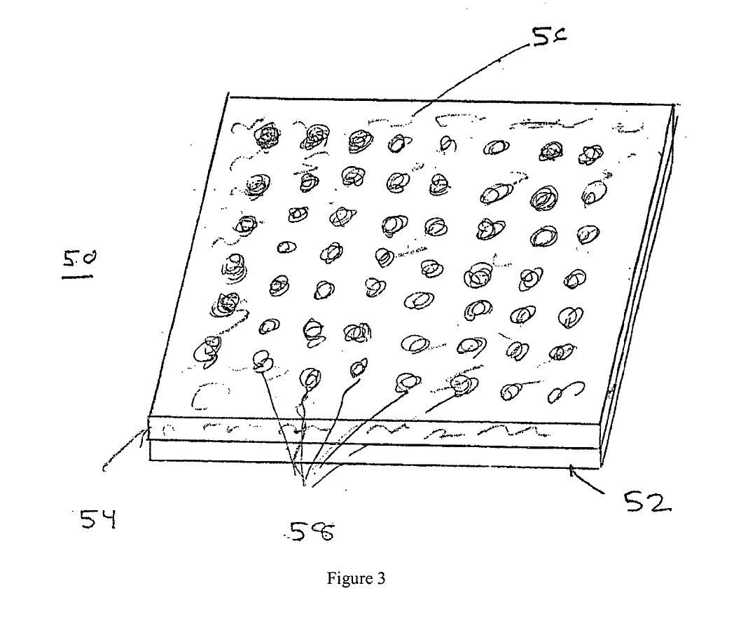

FIG. 3 illustrates a structure suitable as a reinforced sheet resulting from a two-dimensional patterned ground electrode. Reinforced sheeting 50 includes substrate material 52 and layer 54 of electrospun fibers 56. Multiple fiber aggregations 58 constitute discrete, separated small areas of a predetermined pattern in layer 54. The pattern selected will depend upon the end-use application.

### EXEMPLIFICATION

### EXAMPLE 1

A solution of polyethylene oxide polymer (“PEO”) and dimethyl formamide (“DMF”) solvent was prepared in glass bottles having a final concentration of about 12 weight percent of polymer. The bottle was sealed shut to prevent solvent evaporation. Dissolution was observed at room temperature and the solution was used for electrospinning.

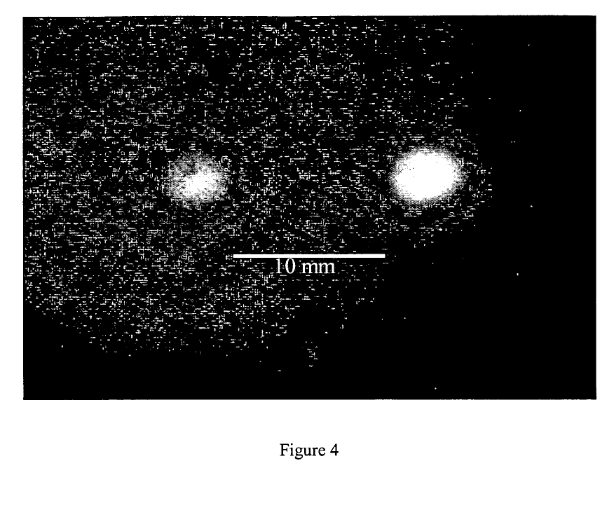

A movable counterelectrode having a circular 1 mm surface dimension was placed at a distance of about 15 cm from the syringe and perpendicular to the syringe tip. A sheet of Mylar® film was interposed between the syringe and the movable counterelectrode, which remain fixed at a distance from the syringe and perpendicular to the syringe tip. A 1.5 kV charge was supplied to the movable electric by a high voltage power supply, resulting in a concentration of electric charge being formed on the electrode. The tip of the syringe was grounded. The spinning process was carried out at room temperature, and the spinning rate was controlled by adjusting the flow of the polymer solution and the electrical field. An aggregation of fibers in the shape of a 4 mm diameter spot on a portion of the Mylar® film, as shown in FIG. 4, was formed.

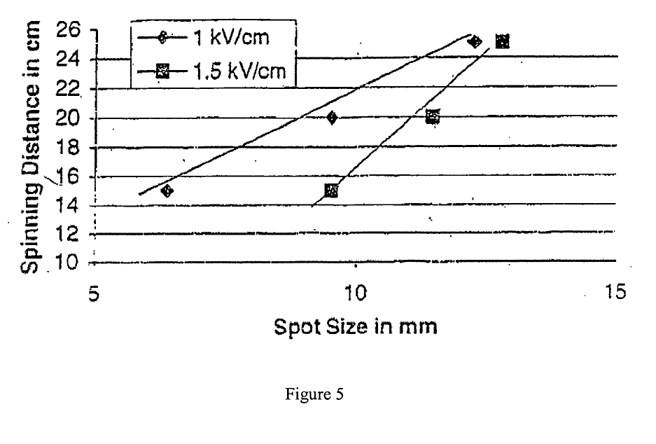

The experiment was repeated using various electrode distances (from about 14 to 25 cm) and either a 1 kV/cm or a 1.5 kV/cm charge levels. As shown in FIG. 5, the spot sizes varied from about 6 to 13 mm in diameter, which demonstrates how the fiber aggregate size can be influenced by the varying the distance between the counterelectrode and the collecting surface.

### EXAMPLE 2

The electrospinning of Example 1 was repeated, except that the movable electrode was moved in the x-y plane to deposit the electrospun fibers on the Mylar® film to form a patterned structure having a selected predetermined specific surface pattern. A X-Y programable controller was used to control the movement of the movable electrode to form a surface pattern characterized by multiple fiber aggregations having the appearance of circular spots on in the Mylar® film, with the spots essentially separated from each other. The areas between the spots also contained fiber deposited during the movement of the electrode from spot to spot, but had considerable lesser depth than the spots.

A control example was performed using the same electrospinning process except that a large surface area electrode having a smooth surface was used and the electrospun fibers were deposited on the Mylar® film in a random manner. Using the same amount of electrospun fiber, the deposited fiber formed a layer of essentially uniform thickness.

### EXAMPLE 3

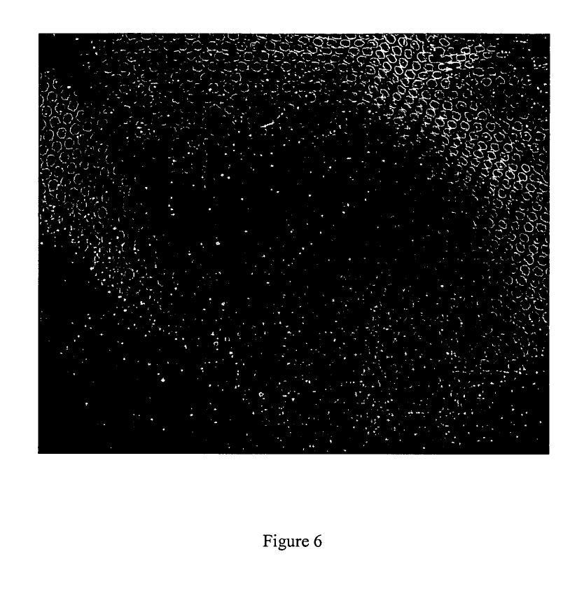

FIG. 6 is a photograph of electrospun fibers and a pattern of fiber aggregation created using the articles and methods of this invention. The fibers were deposited on a Kapton® polyimide film using a continuous metal sheet with 0.25 inch diameter holes as the ground electrode.

### EXAMPLE 4

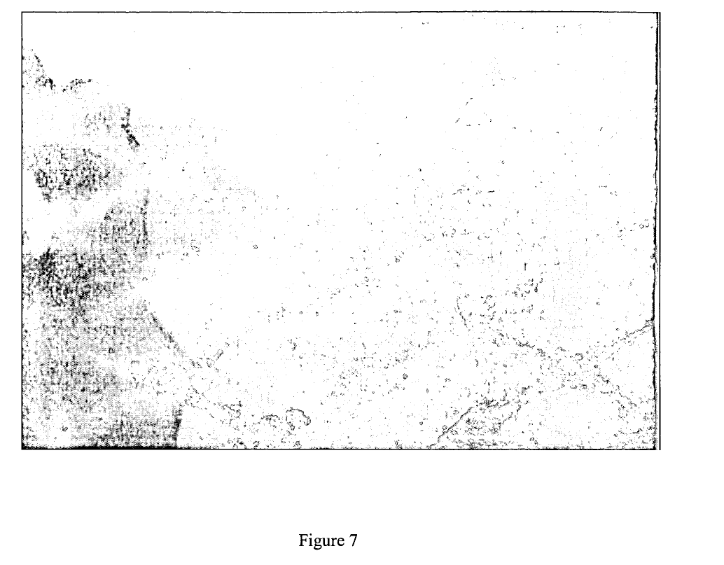

FIG. 7 is a photograph of electrospun fibers and a pattern of fiber aggregation created using the articles and methods of this invention. The fibers were deposited onto a camouflage fabric substrate.

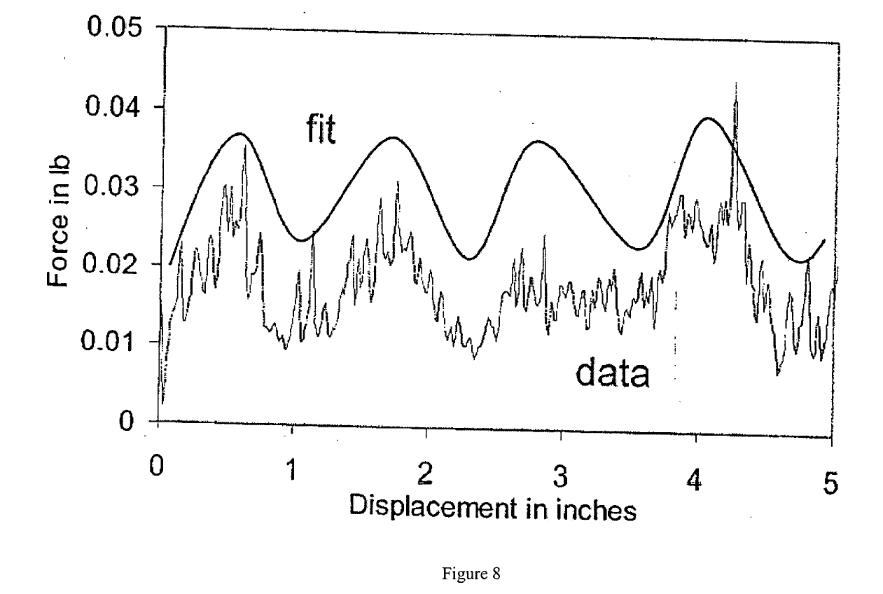

FIG. 8 illustrates a graph of the force required during delamination of the patterned adhesive shown in FIG. 7. The graph shows period consistent with the spacing of the pattern.

### EXAMPLE 5

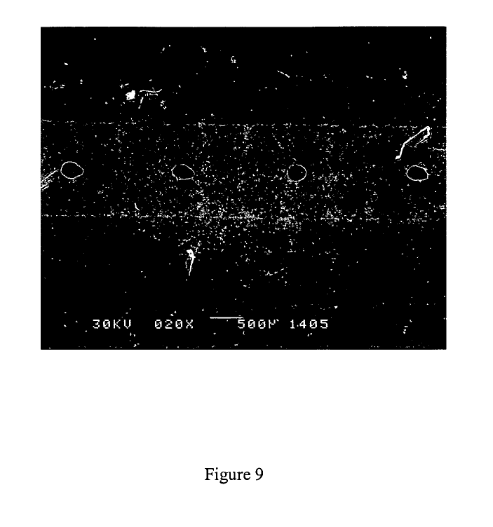

FIG. 9 illustrates a scanning electron microscope image of a 0.5 mm wide patterned electrospun rip-stop reinforcement strip created using the articles and methods of this invention. The rip-stop reinforcement strip was deposited onto a thin polyimide film. The spots in the stripe are inkjet printed solvent welds.

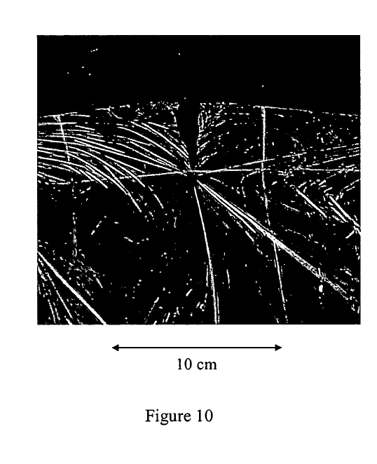

FIG. 10 is a photograph of a Mylar® sheet (˜0.9 microns thick; E.I. du Pont de Nemours and Company Corp.) patterned with the electrospun rip-stop reinforcement illustrated in FIG. 9 using the articles and methods of this invention. Tear propagation is seen through the film, but the propagation stops at the electrospun reinforcement.

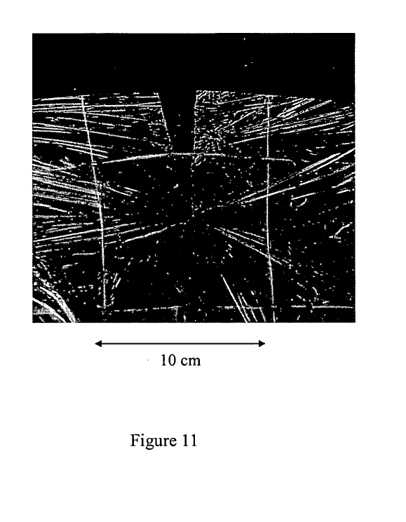

FIG. 11 is a photograph of the film shown in FIG. 10 after subjected to additional tear propagation. Tear propagation is seen through the film, but the electrospun reinforcement holds the film together.

### EQUIVALENTS

While this invention has been particularly shown and described with references to preferred embodiments thereof, it will be understood by those skilled in the art that various changes in form and details may be made therein without departing from the scope of the invention encompassed by the appended claims.

1. A method for forming a patterned polymer structure, comprising the step of directing a polymer from a source electrode into an electric field that drives the polymer to form electrospun fibers and deposits the electrospun fibers onto a collecting surface in a pattern, thereby forming a patterned polymer structure.

2. The method of claim 1 wherein the electrospun fibers are deposited onto a collecting surface that is a counterelectrode.

3. The method of claim 1 wherein the electrospun fibers are deposited onto a collecting surface that is between the source electrode and a counterelectrode.

4. The method of claim 3 wherein the electrospun fibers are deposited onto a portion of the collecting surface.

5. The method of claim 3 wherein the counterelectrode forms a pattern of electric charge and the electrospun fibers are deposited on the collecting surface as the patterned structure.

6. The method of claim 1 wherein the patterned structure is formed by moving either or both the electric charge and the collecting surface relative to each other.

7. The method of claim 6 wherein the relative movement is intermittent.

8. The method of claim 6 wherein the relative movement is continuous.

9. The method of claim 4 wherein field lines of the electric field intersect the collecting surface and the electrospun fibers are deposited on the portion of the collecting surface at which the field lines intersect the collecting surface, whereby the patterned structure is formed.

10. The method of claim 9 further comprising moving the counterelectrode whereby the intersection of the field lines with the collecting surface is changed in relationship to the movements.

11. The method of claim 10 further comprising moving multiple counterelectrodes.

12. The method of claim 9 further comprising moving the collecting surface, whereby the intersection of the field lines with the collecting surface is changed in relationship to the movements.

13. The method of claim 4 wherein field lines of the electric field form an array of concentrations of electric charge at the collecting surface, whereby the electrospun fibers are deposited as a patterned structure that includes an array of aggregations of electrospun fibers.

14. A method for forming a patterned structure of electrospun fibers, comprising the steps of:
(a) electrically directing fiber-forming polymeric material from a spinning source in an electric field created by source and counterelectrodes, the counterelectrode forming concentrations of electrical charges which include a patterned array in a plane that traverses the electric field; and
(b) interposing a collecting surface at the plane, whereby the directed fibers are deposited on the collecting surface in aggregations that are essentially the same pattern as formed by the concentrations of electrical charge.

15. The method of claim 14 wherein the concentrations of electrical charge an moved to form the patterned array.

16. The method of claim 12 wherein the collecting surface is interposed by moving the collecting surface in the electric field in a direction that is essentially parallel to the plane.

17. A method for forming a patterned structure of electrospun fibers, comprising the steps of directing a polymer stream into an electric field created by source and counterelectrodes, the electric field including a pattern of electric charge at a collecting surface between the source and counterelectrodes, whereby the polymer stream splays to form electrospun fibers that deposit onto the collecting surface as a structure having the pattern of electric charge at the collecting surface.

18. Apparatus for forming a patterned array of electrospun fibers, comprising:
(a) means for electrically directing fibers from a spinning source in an electric field created by one or more source and counterelectrodes, the one or more counterelectrodes producing at least one concentration of electrical charge; and
(b) a collecting surface between the source and counterelectrodes.

19. The apparatus of claim 18 wherein the means for electrically directing fibers is movable relative to the collecting surface.

20. The apparatus of claim 18 wherein the means for electrically directing fibers moves the one or more counterelectrodes such that the movements of the concentration of electrical charge form a structure in essentially the same pattern as the pattern formed by the movements of the concentrations of electric charge.

21. The apparatus of claim 18 wherein each of the concentrations of electrical charges is essentially circular.

22. Apparatus of claim 18 wherein the means for electrically directing electrospinning fibers comprises one or more counterelectrodes, the concentration of electrical charge of which form a patterned array.

23. Apparatus of claim 18 wherein the collecting surface is polymeric film.

24. Apparatus of claim 18 further comprising means to move the collecting surface.

25. An article of manufacture, comprising multiple aggregations of polymeric electrospun fibers defining at least one area between the aggregations.

26. The article of manufacture of claim 25 further comprising a planar member upon which the multiple aggregations are positioned, thereby forming a composite structure.

27. The article of manufacture of claim 25 wherein the planar material is a film.

28. The article of manufacture of claim 25 wherein the electrospun fibers include multiple essentially circular aggregations.

29. An article of manufacture produced by the method of claim 1.
